(19) United States
(12) Patent Application Publication
(10) Pub. No.: US 2009/0326780 A1
(43) Pub. Date: Dec. 31, 2009

(54) METHOD FOR DISTANCE CONTROL

(75) Inventors: Franz Waibel, Bad Wurzach-Usa (DE); Martin Gasser, Diepoldsau (CH)

Correspondence Address: FASSE PATENT ATTORNEYS, P.A., P.O. BOX 726, HAMPDEN, ME, 04444-0726, US

(73) Assignee: ADC Automotive Distance Control Systems GmbH, Lindau (DE)

(21) Appl. No.: 12/310,184

(22) PCT Filed: Jul. 26, 2007
(86) PCT No.: PCT/DE2007/001320

§ 371 Date: Feb. 13, 2009

(30) Foreign Application Priority Data
Aug. 16, 2006 (DE) 10 2006 038 490.3

(51) Int. Cl. B60W 30/16

(52) U.S. Cl. 701/96

(57) ABSTRACT

The invention relates to a method for distance control of the vehicle in question in relation to a vehicle driving ahead, which method is distinguished in that the vehicle in question is kept at a distance from a vehicle driving ahead by a drive torque (M) which is predefined by means of an accelerator pedal position (G) which is set by the driver.

The invention relates to a method for distance control.

Driver's assistance systems based on sensors already exist for distance control, which monitor and measure the surroundings in front of vehicles. Based on the gained measurement values, such as for example distance and relative speed to the vehicle driving ahead, a distance is calculated, which is adapted to the traffic conditions and to legality, i.e. in particular to the legal and other regulations and provisions. Many systems then assume the longitudinal regulation of the driver and control the vehicle without any help of the driver. The driver has only limited influence capabilities on the drive torque of the vehicle as long as the system is active.

However, many drivers are uncomfortable being no longer part of the control circuit for the distance control. They criticize the lost possibility to intervene on the drive torque. And that in particular on the way usual for the driver by means of operating the accelerator pedal.

It is the object of the invention to provide to the driver or to the vehicle operator more influence capabilities during distance control.

The object is solved according to invention with a method, which comprises the features indicated in claim 1.

Advantageous embodiments of the invention are subject of the sub-claims.

The method according to the invention is characterized in that a vehicle in question is kept at a distance from a vehicle driving ahead by a drive torque which is predefined by means of an accelerator pedal position which is set by the driver.

The advantages achieved with the invention consist in particular of the fact that in case of an active driver's assistance function the driver of a vehicle remains involved in a longitudinal regulation of the vehicle and thus maintains influence capabilities on the drive torque, in particular by means of the accelerator pedal.

In detail, the accelerator pedal position, which is controlled by the driver of the vehicle, is detected by means of a sensor, e.g. a potentiometer, and is transmitted to an actuator for adjustment of a drive torque pertaining to the accelerator pedal position. This actuator controls the transmission ratio between a path of the accelerator pedal and a process of the drive torque. From the fact that in present vehicles the accelerator pedal position is usually detected on the basis of a sensor and is transmitted to an actuator for the control of the drive torque, it results that for detecting the accelerator pedal position and for adjusting the drive torque no additional arrangements are necessary to implement an assistance system for distance control. Thus, a simple solution which can be designed cost-efficiently is indicated.

In this case each accelerator pedal position leads to a single drive torque. For this purpose several characteristic curves of the drive torque are given depending on the accelerator pedal position, which are deposited in the actuator. These characteristic curves are characterized by a different transmission ratio between the accelerator pedal position and the corresponding drive torque. Merely the drive torques, pertaining to a minimum and a maximum accelerator pedal position, no drive torque and a maximum drive torque are equally designed in all deposited characteristic curves. Thus, even with an active assistance function the driver of the vehicle has the entire range of the drive torque available and the usual, monotonously rising behavior of the drive torque in case of a stronger actuation of the accelerator pedal is maintained and controllable by the driver. Further, on the basis of the different characteristic curves it is possible to adapt the transmission ratio between the accelerator pedal position and the drive torque to the most diverse requirements.

Which characteristic curve of the drive torque is predetermined dependent on the accelerator pedal position depends e.g. on the distance and/or relative speed the vehicle in question has to that driving ahead. The current distance and/or the relative speed are detected on the basis of sensors, e.g. radar, ultrasonic sensors, infrared sensors, picture recording units and are transmitted to the actuator. The relative speed of the vehicle in question to the vehicle driving ahead can be determined for example from the change of the distance in a given time interval, e.g. by computational processing or directly via the Doppler effect. Today's vehicles are usually equipped with suitable arrangements for determining one's own speed. Therefore, it is merely necessary to additionally equip one's own vehicle with sensors to determine the distance and/or relative speed. By means of this and by the simple feasibility of the calculation of the relative speed an assistance system for distance control is created, which can be produced at low material expenditure and resulting therefrom at low costs. Further, on the basis of this low expenditure the possibility of subsequent equipping vehicles with the assistance system for distance control is given.

The required distance to the vehicle driving ahead is determined dependent on the traffic conditions and/or legal or other provisions. Thus, a distance to the vehicle driving ahead adapted to traffic conditions and to legal provision is achieved and safety is increased. In case of a smaller current distance than that which is predetermined according to the respective situation the corresponding drive torque is reduced on the basis of the actuator with a constant accelerator pedal position. This leads to the advantage that the distance of the vehicle in question to the vehicle driving ahead, in particular due to the constant accelerator pedal position, is increased with the driver nearly not noticing.

The method for distance control is implemented by means of the integration of the apparatuses specified above into a control loop. This control loop is characterized in that at least one sensor measures the distance of the vehicle in question to that driving ahead and that this distance value is compared to a fixed predetermined distance value adapted to the vehicle situation. If the measured distance to a vehicle driving ahead is smaller than the predetermined value, then the drive torque pertaining to the current accelerator pedal position is reduced on the basis of the actuator. Based on the reduction of the speed of the vehicle in question resulting therefrom the distance to the vehicle driving ahead is increased. The simple structure and the straightforward active principle of the control loop result in a trouble-free and maintenance-free function of the assistance system for distance control.

As a summary the distance behavior of the driver of the vehicle improves on the basis of the assistance system for distance control and unintentional exceedings of the distance e.g. due to long monotonous travels are avoided. Simultaneously, however, the driver of the vehicle has the possibility with an active assistance function, to retrieve the entire range of the drive torque wherein in particular the minimum and maximum drive torque are always available with the same accelerator pedal positions.

Examples of embodiments of the invention will become apparent from a drawing, in which

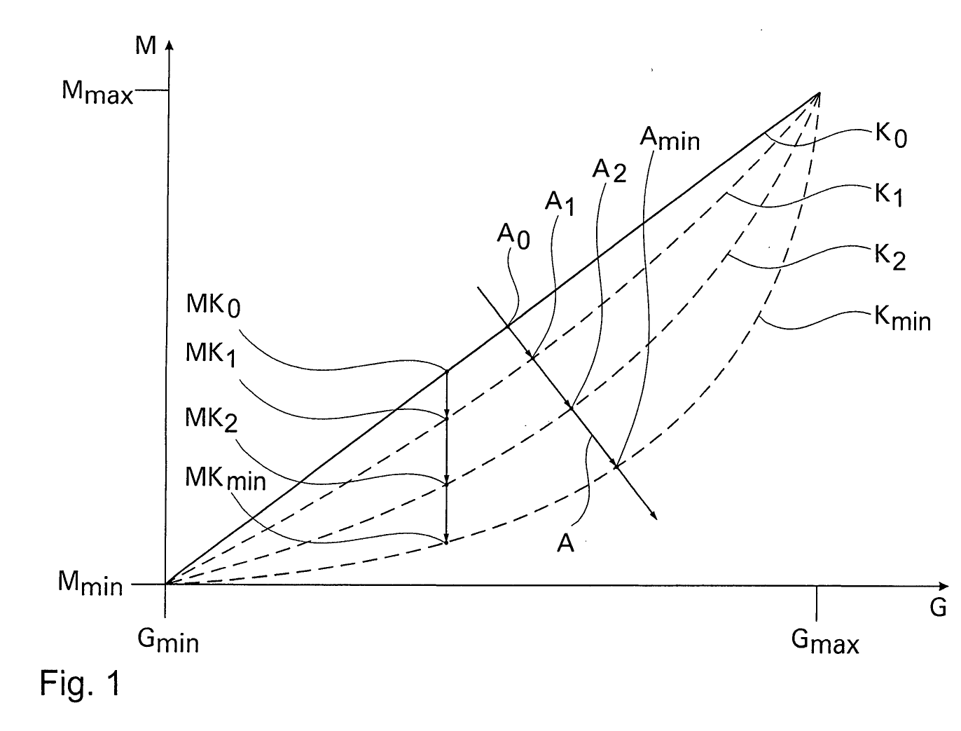

FIG. 1 shows schematically a diagram, which includes the functional dependency of the drive torque on the accelerator pedal position.

On the basis of a diagram FIG. 1 shows how a drive torque M pertaining to an accelerator pedal position G changes with a distance reduction A of a vehicle in question not represented in detail to a vehicle driving ahead not represented in detail. A characteristic curve K1 shows a process of the drive torque M dependent on the accelerator pedal position G, which is not affected by the intervention of an assistance system for distance control. The unaffected characteristic curve K0 is characterized by a linear process between an interface of a minimum accelerator pedal position Gₘᵢₙ and a minimum drive torque Mₘᵢₙ as well as an interface of a maximum accelerator pedal position Gₘₐₓ and a maximum drive torque Mₘₐₓ. That means that the drive torque M rises linearly with the accelerator pedal position G, which a driver not represented in detail predetermines. The initial characteristic curve K0 can show also another arbitrary process between the interfaces of the minimum accelerator pedal position Gₘᵢₙ and the minimum drive torque Mₘᵢₙ as well as a maximum accelerator pedal position Gₘₐₓ and a maximum drive torque Mₘₐₓ, however, it is always embodied in monotonously rising manner.

A current distance of the vehicle in question to that driving ahead is determined by means of a sensor not represented in detail. This current distance is compared to a fixed predetermined distance value, which corresponds to the vehicle situation as well as to legal and other provisions. In case of a distance reduction A below this predetermined distance value to a distance A1 the unaffected drive torque MK0 is reduced with a constant accelerator pedal position G to a reduced drive torque MK1 pertaining to a characteristic curve K1 deposited in the actuator by means of an actuator not represented in detail. By means of the constant accelerator pedal position G the distance of the vehicle in question to the vehicle driving ahead is increased with the driver nearly not noticing, unless the driver does not counteract to the intervention of the distance control by stronger actuating the accelerator pedal.

By this stronger actuation or on the basis of other incidents in the surroundings of the vehicle, e.g. deceleration of the vehicle driving ahead, the distance to the vehicle driving ahead can be further reduced to a distance A2. With a reduction to this distance A2 by means of the actuator with a constant accelerator pedal position G the drive torque M is further decreased to a reduced drive torque MK2, which pertains to a characteristic curve K2 deposited in the actuator. Thus, it is acted against the distance reduction A.

In case of a further distance reduction A to a minimum distance Aₘᵢₙ the drive torque M is further reduced by means of the actuator. This reduction of the drive torque M is effected when reaching the minimum distance Aₘᵢₙ pertaining to a certain vehicle situation to a reduced drive torque MKₘᵢₙ pertaining to the characteristic curve Kₘᵢₙ, in order to counteract to the distance reduction A. The characteristic curve Kₘᵢₙ here represents the strongest intervention of the assistance system on the process of the drive torque M dependent on the accelerator pedal position G.

Irrespective of the strength of the intervention of the assistance system to the distance control all characteristic curves K0, K1, K2, Kₘᵢₙ deposited in the actuator are characterized by the same minimum drive torque Mₘᵢₙ with a minimum accelerator pedal position Gₘᵢₙ and the same maximum drive torque Mₘₐₓ with a maximum accelerator pedal position Gₘₐₓ. The various characteristic curves K0, K1, K2, Kₘᵢₙ are characterized in that the process of the respective drive torque M between the points of the minimum drive torque Mₘᵢₙ and the maximum drive torque Mₘₐₓ is embodied with stronger distance reduction A in increasingly arch-formed manner, i.e. displaced to lower values of the drive torque M. The characteristic curves K0, K1, K2, Kₘᵢₙ are predetermined over the entire process as monotonously increasing. Here, however, the increase of the drive torque M reduces with increasing distance reduction A with low accelerator pedal positions G, however increases with higher accelerator pedal positions G with increasing distance reduction A more and more stronger in non-linear manner. That means that the driver of the vehicle has the entire range of the drive torque M available even with an active assistance system, only a transmission ratio between a path of the accelerator pedal and the drive torque is changed by the actuator. Thus, the distance behavior is improved for the driver of the vehicle nearly without him noticing and the safety for the vehicle and its environment is increased, as long as the driver does not act deliberately against the assistance system for distance control.

1-14. (canceled)

15. A method for distance control of a subject vehicle in relation to a leading vehicle driving ahead of the subject vehicle, characterized in that the subject vehicle is kept at a distance from the leading vehicle by a drive torque (M) which is suitably predefined by means of an accelerator pedal position (G) which is set by the driver of the subject vehicle.

16. The method according to claim 15, characterized in that the drive torque (M) pertaining to the accelerator pedal position (G) is controlled variably in magnitude, excluding a minimum drive torque (Mₘᵢₙ) pertaining to a minimum accelerator pedal position (Gₘᵢₙ) and a maximum drive torque (Mₘₐₓ) pertaining to a maximum accelerator pedal position (Gₘₐₓ).

17. The method according to claim 16, characterized in that the magnitude of the variably controllable drive torque (M) is predetermined dependent on the distance and/or a relative speed of the subject vehicle to the leading vehicle.

18. The method according to claim 17, characterized in that the distance to the leading vehicle is determined dependent on a traffic situation and/or on legal or other provisions.

19. The method according to claim 15, characterized in that several characteristic curves of the drive torque (M) are predetermined dependent on the accelerator pedal position (G).

20. The method according to claim 15, characterized in that if the distance to the leading vehicle is too short, then the drive torque (M) pertaining to the current accelerator pedal position (G) is reduced.

21. A device for carrying out the method according to claim 15, said device comprising
a control loop for control of the distance to the leading vehicle, comprising a sensor for recording the accelerator pedal position (G), an actuator for adjusting the drive torque (M), and at least one sensor for determining the distance to the leading vehicle, and
a memory storage unit on which a program executing a method according to claim 15 is recorded.

22. The device according to claim 21, characterized in that the sensor which records the accelerator pedal position (G) transmits the accelerator pedal position to the actuator and/or the sensor for determining the distance to the leading vehicle transmits this distance to the actuator.

23. The device according to claim 21, characterized in that the actuator controls a transmission ratio between a travel of the accelerator pedal and a progression of the drive torque (M), and in that different characteristic curves of the drive torque (M) are stored in the actuator dependent on the accelerator pedal position (G).
